(19) United States
(12) Patent Application Publication
(10) Pub. No.: US 2008/0182743 A1
(43) Pub. Date: Jul. 31, 2008

(54) Methods of Heat-Treating Particulate Material

(75) Inventors: Ismail Yildirum, Milledgeville, GA (US); Robert J. Pruett, Milledgeville, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Imerys Pigments, Inc., Roswell, GA (US)

(21) Appl. No.: 11/913,423

(22) PCT Filed: May 1, 2006
(86) PCT No.: PCT/US06/16346

§ 371 Date: Nov. 2, 2007

Related U.S. Application Data
(60) Provisional application No. 60/676,294, filed on May 2, 2005.

(51) Int. Cl. C04B 14/10; B05D 7/00; C04B 33/00; B05C 11/00

(52) U.S. Cl. 501/141; 427/213.3; 106/486; 106/450; 118/47

(57) ABSTRACT

Disclosed herein is a method of heat-treating particulate material, such as kaolin. The method comprises providing a feed mixture comprising a particulate material, such as hydrous kaolin, wherein at least a portion of the particulate feed is coated with an additive/liquid fuel mixture comprising at least one additive dispersed in liquid fuel. The method further comprises heating the particulate feed to heat treat, e.g., calcine, the particulate feed and burn the liquid fuel to form a heat-treated product. The liquid fuel coating can act as a secondary, indirect heat source for heat treating.

This application claims priority to U.S. Provisional Patent Application No. 60/676,294 filed on May 2, 2005.

The present invention relates to new methods for heat-treating particulate materials, such as kaolin, and to methods of delivering additives to particulate materials. The resulting products can have many uses, such as fillers or extenders in paints, plastics, polymers, papermaking, and coating compositions. More generally, the products disclosed herein may be used wherever heat-treated minerals, such as calcined kaolins, are used.

Particulate kaolins occur naturally in the hydrous form and exist as crystalline structures containing at least one hydroxyl functionality. Particulate kaolins may be converted to a calcined form by thermal processes. Such processes cause the particulate kaolin to dehydroxylate. During calcination, the hydrous kaolin converts from a crystalline to an amorphous form. Further, during calcination, aggregation can occur. The size of the aggregates can be as small as a few microns and as large as a few millimeters in diameter, depending on the calcining temperatures involved and/or the calciner type used.

Certain heat treatments of particulate minerals, such as the calcination of kaolin, require high temperature conditions, often ranging from 500° C. to 1200° C., which can result in substantial energy expenditures. It is not surprising to find a calcining process that requires as high as 6 million Btu/ton (based on dry calcine feed rate) of thermal energy to produce fully calcined products from hydrous kaolin.

Accordingly, there remains a need for developing new and efficient heat treating methods, such as calcining methods.

It has at times proven advantageous to add additives, such as TiO₂, to particulate materials, such as kaolin, prior to heat-treatment to improve optical properties of the resulting particulate mineral. For example, additives such as TiO₂ can improve the opacity and light scattering characteristics of a calcined kaolin product. However, hydrophobic additives, such as TiO₂, can floc and form aggregates when added to aqueous suspensions of particulate materials, leading less than ideal dispersion to the surface of the heat-treated material, reducing its beneficial effects on opacity and light scattering.

Accordingly, there is also a need for improved methods for delivering additives to particulate materials prior to heat-treatment.

One aspect of the present disclosure provides a method for heat-treating, comprising:

(a) combining at least one additive in a liquid fuel to form an additive/liquid fuel mixture;

(b) coating at least a portion of a particulate material with the additive/liquid fuel mixture to form a coated particulate material; and

(c) heating the coated particulate material to calcine the particulate material and burn the liquid fuel to form a heat-treated product.

According to this aspect, coating at least a portion of the particulate material with the additive/liquid fuel mixture can provide additional energy for heating the feed. The particulate material can be heated directly, e.g., via heat provided by a kiln, and indirectly via heat generated by burning the liquid fuel. As a result, the calcining can be performed at lower temperatures due to the synergistic effect arising from the use of liquid fuel that coats the particulate material. Accordingly, overall thermal energy requirements for the calcination can be reduced.

The use of a liquid fuel can also be beneficial as a secondary source of heat when compared to solid fuels. For example, liquid fuel can provide a higher heat value than solid fuels. At a given addition rate, fuel oil can yield more heat than any other solid fossil fuel source, such as charcoal, sawdust, organic sludge, and the like. Moreover, the use of liquid fuels, such as hydrocarbons, does not result in the production of ash, which may cause discoloring of the calcined product.

The additive/liquid fuel mixture can be spread throughout the particulate material more homogeneously compared to solid fuels, via coating. As used herein, “coating” refers to coating at least a portion of the accessible outer surface of particulate material, whether it exists as aggregates (if present in the particulate material), or at least a portion of the surface of individual particles. By coating the additive onto the surfaces of the particulate material, improved dispersion of the additive can be achieved. For example, the beneficial effects of a TiO₂ additive on opacity and lights scattering can be improved by increasing dispersion of the TiO₂ and localizing it to the surface of the particulate material.

In one aspect, “liquid fuel” refers to a fuel that is a liquid at operating temperatures. For example, a fuel may be a solid at room temperature but may be sufficiently liquid at the time of mixing with the particulate material to coat the material.

In one aspect, the additive/liquid fuel mixture can take any form, such as a slurry or suspension. In one aspect, the combining in (a) comprises dispersing the at least one additive in the liquid fuel to form an additive/liquid fuel dispersion. In one aspect, the combining can be performed in the presence of at least one dispersant to maintain a suspension. In one aspect, the at least one dispersant may be chosen from acrylate based organic dispersants such as sodium polyacrylate, ammonium polyacrylate, sodium polyacrylamide, etheylene oxide-propylene oxide co-polymers; inorganic dispersants such as sodium silicate, sodium metasilicate, sodium hexametaphosphate, and tetrasodium pyrophosphate; and alcohol-based dispersants such as 2-amino-2-methyl-1-propanol. Other organic dispersants may also be used for this application, such as soya lecithin based dispersants, and sorbitan based dispersants such as sorbitan tritallate and ethoxylated sorbitan tritallate.

In one aspect, the at least one additive can be any material capable of undergoing a chemical or structural change upon heating the liquid fuel.

In one aspect, the at least one additive can include minerals chosen from TiO₂, zirconia, silica such as diatomaceous earth silica (diatomite), aluminum trihydrate, calcium oxide, magnesium oxide, and calcium carbonate such as precipitated calcium carbonate (PCC), and ground calcium carbonate (GCC).

In another aspect, the at least one additive can include at least one metal. When provided as an additive, the at least one metal can be heated by the fuel, which is eventually burned off, resulting in depositing of the metal directly on the surface of the particulate. In one embodiment, this deposition can form a composite material. In another embodiment, the deposition can result in precipitation of the metal on the surface. Exemplary metals include first and second row transition metals, such as chromium, cobalt, titanium, zirconium, and yttrium, and noble metals, such as copper, gold, silver, platinum, palladium, and iridium.

In one aspect, the at least one additive is chosen to optimize the light scattering properties (e.g., opacity) of the resulting calcined product. The amount of additive can be chosen in the range of 0.1-2% by weight of teed material to be calcined. The particle size distribution of solid additives can be in the range of 100 nanometer to 2-3 micron in diameter measured using either Sedigraph 5100 or light scattering. Exemplary benefits of adding such additives into the feed material, such as calcine feed material, may include at least one of increased pigment brightness, improved light scattering properties, and improved retention of filler and paper fiber during paper making.

In one embodiment, particle sizes, and other particle size properties referred to in the present disclosure, are measured using a SEDIGRAPH 5100 instrument as supplied by Micromeritics Corporation. The size of a given particle is expressed in terms of the diameter of a sphere of equivalent diameter, which sediments through the suspension, i.e., an equivalent spherical diameter (esd). All particle size data measured and reported herein, including in the examples, were taken in a known manner, with measurements made in water at the standard temperature of 34.9° C. All percentages and amounts expressed herein are by weight. All amounts, percentages, and ranges expressed herein are approximate.

In one aspect, pigment color can be assessed with Hunter L* a* b* coordinates, where components a, b, and L are the color component values on the color space scale as measured by a Hunter Ultrascan XE instrument. “+a” is a measure of red tint; “−a” is a measure of green tint; “+b” is a measure of yellow tint; “−b” is a measure of blue tint; “L” is a measure of whiteness. The process disclosed herein can result in improved Hunter “a” and “b” values. As used herein, the more negative “a” value and the lower “b” value is indicative of better product quality.

In one aspect, “at least a portion of the particulate material” refers to at least about 50% of the particulate material being coated with liquid fuel. In another aspect, at least about 60% of the particulate material is coated with liquid fuel, such as at least about 75%, at least about 80%, at least about 90%, at least about 95% of the particulate material is coated. The adsorption density of liquid fuel on the particulate material (or the percentage of particle surface coated with liquid fuel) can be determined qualitatively and quantitatively by means of a variety of experimental methods such as BET, FTIR, XPS, differential thermal analysis, thermogravimetric analysis, analysis of VOC's and hydrocarbons, oil absorption testing, inverse gas chromatography, flash point testing, microcalorimetry, differential scanning calorimeter, etc.

The liquid fuel can be present in relatively small amounts to achieve the synergistic effect. In one aspect, the liquid fuel is present in the feed mixture in an amount ranging from about 0.01% to about 5% by weight, relative to the total weight of the feed mixture. In another aspect, the liquid fuel is present in the feed mixture in an amount ranging from about 0.01% to about 1% by weight, relative to the total weight of the feed mixture.

In one aspect, the particulate material, such as hydrous kaolin, can exist as individual particles and/or aggregates of the individual particles. Accordingly, in one aspect, the particulate material, such as hydrous kaolin, is chosen from aggregates and individual particles. “Chosen from” or “selected from” as used herein refers to selection of individual components or the combination of two (or more) components. For example, the particulate material can comprise aggregates only, individual particles only, or a mixture of aggregates and individual particles.

In one aspect, the particulate material in (b) is finely disseminated.

In one aspect, the feed may be a dry material and may include aggregates. For example, the particulate material in (b) may have a mean dispersed particle size ranging from about 0.1 μm to about 500 μm. The mean particle size, or the d₅₀ value, is the value of the particle esd at which there are 50% by weight of the particles, which have an esd less than that d₅₀ value.

In one aspect, mean particle size of a dispersed particle phase can be quantified using the Sedigraph 5100 or light scattering techniques, e.g., by using a laser light scattering technique to measure particle size by a Microtrac Model X100 Particle Size Analyzer, as supplied by Microtrac.

In one aspect, the particulate material is chosen from hydrous kaolin having a mean dispersed particle size equal to or less than about 2 μm, i.e., the individual particles or aggregates have a mean dispersed particle size equal to or less than about 2 μm. In another aspect, the particulate hydrous kaolin has a mean dispersed particle size equal to or less than about 0.5 μm. In another aspect, the particulate hydrous kaolin has a mean dispersed particle size equal to or less than about 1 μm, such as a mean dispersed particle size equal to or less than about 0.15 μm.

The liquid fuel may be an organic material. In one aspect, the liquid fuel comprises a hydrocarbon oil. Exemplary hydrocarbon oils include fuel oils, vegetable oils, modified vegetable oils, waste oils, aliphatic and aromatic alcohols, and biodiesels.

Exemplary fuel oils include kerosene, petroleum, mineral oil, turpentine, gasoline, diesel, No. 2 fuel oil, No. 4 fuel oil, No. 5 light fuel oil, No. 5 heavy fuel oil, and No. 6 fuel oil. Representative vegetable oils include canola oil, soybean oil, corn oil, palm oil, olive oil, sunflower oil, cottonseed oil, peanut oil, sesame oil and safflower oil. The vegetable oils can comprise one or more fatty acids. The modified vegetable oils can be methyl-, ethyl-, propyl-, butyl, (or higher alkyl) esters of canola oil, soybean oil, corn oil, palm oil, olive oil, sunflower oil, cottonseed oil, peanut oil, sesame oil and safflower oil. Exemplary waste oils include industrial and domestic waste oils, such as waste fat and grease oil, used motor oil, and biodiesels of waste oils.

In one aspect, the liquid fuel is water. Water can increase the density of the bed material that is heated in (c), and thus, may improve calcination.

In one aspect, coating the particulate material with the liquid fuel may be accomplished with a mixer. A mixer can be any device capable of coating the particulate material, e.g., a coater. For example, a high or low intensity mixer can be used for mixing/coating the calcine kaolin feed with the additive/liquid fuel. One example of a high intensity mixer is a Gunter Papenmeier GmbH & Co, Detmold, Germany, Model No: TGAHK 8, ID Number: 4564, which has an 8-liter capacity, stainless steel jacketed bowl with two stage mixing blades rotating from the bottom of the vessel. The rotational speed of mixing blades can be as high as 4,000 rpm. In one aspect, the rotational speed during coating ranges from about 2,000 to about 3,500 rpm, such as a rotational speed of about 3,000 rpm. In another aspect, the particulate material and the liquid fuel in the mixer are subjected to a tip speed of less than about 10,000 feet per minute, such as a tip speed of less than about 1,000 feet per minute, or less than about 100 feet per minute. The mixer provides homogenous hydrocarbon oil distribution on the surface of individual calcine feed particles or aggregates. Other kinds of high intensity mixers (e.g., Turbulizer™, Ross® Planetary mixer.) may also be used in a continuous or batch application.

In one aspect, a low intensity mixer can be a screw feed auger.

The coating time typically ranges from about 5 seconds to about 10 minutes, such as a coating time ranging from about 3 to about 6 minutes, e.g., about 5 minutes.

The coated particulate material, such as coated calcine feed, may be metered to a calciner through a screw feeder for calcining.

The heating in (c) can be performed at a temperature sufficient to burn the liquid fuel, where the temperature can be determined by one of ordinary skill in the art. In one aspect, the heating in (c) is performed at a temperature sufficient to sinter the surface of the particulate material, or to modify the surface chemistry of the particulate material. In another aspect, where the particulate material is a hydrous kaolin, the heating is performed at a temperature sufficient to at least partially dehydroxylate the hydrous kaolin, as described herein.

In one aspect, the heating is performed at a temperature of at least 100° C., such as a temperatures of at least 200° C., at least 300° C., at least 400° C., at least 500° C., or at least 600° C.

The heat source that may be used for heating include horizontal rotary kilns, tunnel kilns, vertical calciners, and flash calciners. The furnace, kiln, or other heating apparatus used to heat the particulate feed may be of any known kind. In one aspect, the heating is performed with at least one of a rotary kiln, a vertical kiln, a flash kiln and a tunnel kiln.

In one aspect, the particulate material comprises a material chosen from minerals, rocks, cement raw materials, and ceramics raw materials. In another aspect, the particulate material comprises a mineral chosen from, but not limited to, kaolin, alumina, limestone, bauxite, gypsum, magnesium carbonate, calcium carbonate, dolomite, diatomite (diatomaceous earth silica), diatomite, and spodumene.

In one aspect, the product of the heat treatment is a calcined material, such as a calcined kaolin. In another aspect, the product of the heat treatment can comprise a material where the additive is sintered to the surface of the particulate material. Such sintering can prevent later separation and/or segregation of the particulate material and the additive and thus, increase retention of the additive. In another aspect, chemical additives coated onto the surface of the particulate material can react during calcination to modify the surface chemistry of the particulate material. Heat treatment can also be for the production of porous materials, denser materials, abrasive materials and refractories.

In another aspect, the product of the heat treatment is chosen from aggregated products, porous products, abrasive products, refractory products, and cementicious products.

Another aspect provides a method for calcining kaolin, comprising:

(a) combining at least one additive in a liquid fuel to form an additive/liquid fuel mixture;

(b) providing a particulate feed comprising particulate hydrous kaolin, wherein at least a portion of the particulate hydrous kaolin is coated with the additive/liquid fuel mixture; and

(c) heating the particulate feed to at least partially dehydroxylate the hydrous kaolin and burn the liquid fuel.

Prior to the heating in (c), the kaolin can be subjected to one or more well known beneficiation steps to remove undesirable impurities. For example, an aqueous suspension of kaolin clay may be subjected to a froth flotation treatment operation to remove titanium containing impurities in the froth. The slurry can be conditioned with an oleic acid to coat the air bubbles produced in the float cells. The titania minerals adhere to the air bubbles and are floated out of the kaolin slurry. An example of such a flotation process is described in U.S. Pat. No. 3,450,257, to Cundy, which is herein incorporated by reference. This process can result in an improved brightness in the kaolin pigment, e.g., a GE brightness gain ranging from about 0.1 to about 3 units.

Alternatively, or in addition, the kaolin may be passed as a suspension through a high intensity magnetic separator to remove iron containing impurities, prior to the heating in (c). A standard high intensity wet magnetic separator can be used. This process can also result in a brightness gain ranging from about 0.1 to about 3.0 units.

Also optionally, the kaolin can be subjected to a selective flocculation process prior to (c) in which the impurities are flocced out of suspension while the kaolin clay remains in suspension. In one example, a high molecular weight anionic polymer having a molecular weight in excess of one million, or a molecular weight in the range of about 10 to about 15 million can be used. The anionic polymer can be a copolymer of a polyacrylamide or polyampholyte. The refined clay slurry may be ozoned, leached (bleached), and/or filtered. The clay may then be acid flocculated and dried, or may be redispersed in a makedown tank and alternately spray dried. Details of a selective flocculation process can be found in U.S. Pat. No. 4,227,920 to Chapman and Anderson, in which the disclosure at col. 3, lines 19-34 and at col. 4, lines 3-16 is incorporated herein by reference for its teachings of a selective flocculation process. U.S. Pat. No. 5,685,900 to Yuan et al., includes a description of an ozonation process, in which the disclosure at col. 3, line 62 to col. 4, line 7, col. 5, lines 12-26 is incorporated herein by reference for its teachings of an ozonation process.

The phrase, “heating . . . to at least partially dehydroxylate the hydrous kaolin,” as used herein, refers to the process of obtaining calcined kaolin encompassing any degree of calcination. “Calcined kaolin” as used herein refers to a kaolin that has been converted from the corresponding (naturally occurring) hydrous kaolin to the dehydroxylated form by thermal methods. Calcination can change, among other properties, the kaolin structure from crystalline to amorphous. Calcination is effected by heat-treating coarse or fine hydrous kaolin in any known manner, e.g., at temperatures ranging from about 500° C. to about 1250° C., such as temperatures ranging from about 500° C. to about 1200° C.

Accordingly, “at least partially dehydroxylate the hydrous kaolin,” “calcined” (or “calcination”), as used in herein, may encompass any degree or type of calcination, including partial (meta) and/or full and/or flash calcination.

Heating the hydrous kaolin in (c) refers to any of the calcination processes discussed above. Heating to at least one temperature can comprise heating the hydrous kaolin at one temperature only, at two or more different temperatures, or over a range of temperatures. The heating can occur for a time to partially or fully calcine the hydrous kaolin depending on the heating time and temperature. For example, in one aspect, the heating in (c) is carried out for a sufficient time to partially calcine the hydrous kaolin. In another aspect, the heating in (c) is carried out for a sufficient time to fully calcine the hydrous kaolin.

The degree to which hydrous kaolin undergoes changes in crystalline form can depend upon the amount of heat to which the hydrous kaolin is subjected. Initially, dehydroxylation of the hydrous kaolin can occur upon exposure to heat. At temperatures below a maximum of about 850-900° C., the product is often considered to be partially dehydroxylated, with the resultant amorphous structure commonly referred to as a metakaolin. Frequently, calcination at this temperature is referred to as “partial calcination,” and the product may also be referred to as “partially calcined kaolin.” Further heating to temperatures above about 900-950° C. can result in further structural changes, such as densification. Calcination at these higher temperatures is commonly referred to as “full calcination,” and the product is commonly referred to as ‘fully calcined kaolin’.

In one aspect, the heating in (c) comprises heating the hydrous kaolin to at least one temperature ranging from about 900° C. to about 1200° C. Heating “to at least one temperature” encompasses heating the kaolin at a constant temperature, or over a range of temperatures. In one aspect, the hydrous kaolin is heated to at least one temperature ranging from about 950° C. to about 1150° C., or at least one temperature ranging from about 1000° C. to about 1100° C.

Additional calcination may cause formation of mullite. Mullite concentrations can range from about 2% to about 3% by weight, relative to the total weight of the composition, and may be useful in some end-use applications, such as ceramic catalyst substrates, e.g., cordierite substrates. In other aspects, mullite may be present in the composition in an amount ranging from greater than about 2%, greater than about 5%, or greater than about 8%, by weight relative to the total weight of the composition, such that they may also be useful in some end-use applications.

Effective calcining procedures include, but are not limited to, soak calcining and flash calcining. In soak calcining, a hydrous kaolin is heat treated at temperatures ranging from 500° C. to 1200° C., such as temperatures ranging from 800° C. to 1200° C., from 850-900° C., or from 900-950° C., as described herein, for a period of time (e.g., from at least about 1 minute to about 5 or more hours) sufficient to dehydroxylate the kaolin. In flash calcining, a hydrous kaolin is heated rapidly for a period of less than 1 second, typically less than 0.5 second.

The calciners that may be used for heating include horizontal rotary kilns, tunnel kilns, vertical calciners, and flash calciners. The furnace, kiln, or other heating apparatus used to effect calcining of the particulate feed may be of any known kind. In one aspect, the heating in (c) is performed with at least one of a rotary kiln, a vertical kiln, a flash kiln and a tunnel kiln. Known devices suitable for carrying out soak calcining include high temperature ovens and rotary and vertical kilns. Known devices for effecting flash calcining include toroidal fluid flow heating devices, such as those described in WO 99/24360, the disclosure of which is incorporated by reference herein.

It is possible for the calcined kaolin product from (c) to have a GE brightness comparable to or even greater than the GE brightness of a kaolin product calcined from an uncoated hydrous kaolin. For example, similar GE brightness calcined kaolins according to the present disclosure can be achieved at lower calcining temperatures. In one aspect, the calcining temperature required for a liquid fuel coated hydrous kaolin is at least about 50° F. less than the calcining temperature for an uncoated hydrous kaolin, such as a calcining temperature of about 100-150° F. less than the calcining temperature for an uncoated hydrous kaolin. These lower temperatures assume comparable samples of hydrous kaolin and the same extent of calcining (e.g., full calcination, partial calcination, etc.).

In one aspect, the calcined product from (c) is chosen from calcined kaolin, calcined alumina, calcined lime, calcined gypsum, calcined bauxite, calcined/fused magnesium carbonate, calcined silica, calcined diatomite, calcined calcium carbonate, calcined dolomite, calcined spodumene, cement, and ceramics products.

Another aspect provides a method for calcining kaolin, comprising:

(a) providing a particulate feed comprising particulate hydrous kaolin, wherein at least a portion of the particulate hydrous kaolin is coated with an additive/liquid fuel mixture, wherein the additive/liquid fuel mixture comprises at least one additive dispersed in liquid fuel; and

(b) heating the particulate feed to at least partially dehydroxylate the hydrous kaolin and burn the liquid fuel.

Another aspect provides a feed mixture, such as a calciner feed mixture, comprising:

a particulate feed chosen from aggregates and discrete particles, wherein at least a portion of the particulate feed is coated with an additive/liquid fuel mixture, the mixture comprising at least one additive dispersed in liquid fuel.

Another aspect provides a system for heat treating a particulate feed, comprising:

(a) a mixer for receiving and mixing particulate material with an additive/liquid fuel mixture to form a pre-dispersed particulate feed, the additive/liquid fuel mixture comprising at least one additive dispersed in liquid fuel; and

(b) a heat source for heating the coated particulate feed and for burning the liquid fuel.

The mixer and heat source can be discrete components, or can be connected, as understood by one of ordinary skill in the art, to form a continuous system. In one aspect, the heat source is a calciner for calcining the particulate feed.

In one aspect the mixer is a high intensity speed mixer containing blades capable of various rotational speeds. The heat source, such as a calciner, can be chosen from a rotary kiln, a vertical kiln, a flash kiln, and a tunnel kiln, or any other heat sources disclosed herein.

In one aspect, the system further comprises a low intensity mixer such as a screw feed auger for mixing/coating, as well as for metering the feed particulate material to the heat source.

In one aspect, the product exiting the heat source in (b) has a steeper particle size distribution than the particulate material in (a). Particle size distribution (psd) of particulate material is often characterized by a “steepness.” Steepness is derived from the slope of a psd curve, where the particle diameter is plotted on the x-axis against a cumulative weight percentage of particles on the y-axis. A wide particle distribution has a low steepness value, whereas a narrow particle size distribution gives rise to a high steepness factor. In one aspect, the steepness is measured by a ratio of d₃₀/d₇₀, as determined by Sedigraph 5100. The values d₃₀ and d₇₀ are the particle equivalent spherical diameter (“esd”) at which there are 30% and 70% by weight of the particles, respectively, which have an esd less than the d₃₀ and d₇₀ values.

In one aspect, the product exiting the heat source has a steepness value of at least about 58, such as a steepness value of at least about 60, as determined by the ratio d₃₀/d₇₀×100.

The calcined kaolin compositions disclosed herein can be used for a variety of applications where increased opacity, whiteness or sheen/gloss control are desired. For example, the calcined kaolin products disclosed herein can be used in coating compositions in which any one of these characteristics are desired. Products disclosed herein may also be useful wherever kaolins are used, such as in making filled plastics, rubbers, sealants, and cables, or they may be used in the manufacture of ceramic products, cementitious products, and paper products and paper coatings.

Calcined kaolins can be used to improve the opacity of a pigment and find widespread use as pigments in paints, plastics, rubbers, sealants, and as raw materials for ceramics, cementitious products and other application compositions. For example, calcined kaolins can be used as flatting (or matting) agents in paints and coatings. They can help control the gloss and sheen of the surfaces of a final, dried paint film. Regarding optical paint film properties, they can impart opacity, whiteness, and other desirable properties. They can also serve as extenders by partial replacement of titanium dioxide and other more expensive pigments with minimal loss of whiteness or opacity.

The products and compositions disclosed herein can be used in the production of all paper grades, from ultra lightweight coated paper to coated or filled board. Paper and paperboard products can comprise a coating, which can improve the brightness and opacity of the finished paper or board.

The disclosed products can also serve as extenders, allowing the partial replacement of expensive titanium dioxide pigments without unacceptable loss of opacity or tint strength. The extender material can be used in paper, polymers, paints and the like or as a coating pigment or color ingredient for coating of paper, paper board, plastic, papers and the like.

Paint compositions comprising calcined kaolin and optionally at least one ingredient chosen from thickeners, dispersants, and biocides, as described herein, may additionally comprise at least one additional ingredient chosen from a polymeric binder, a primary pigment such as titanium dioxide, a secondary pigment such as calcium carbonate, silica, nepheline syenite, feldspar, dolomite, diatomaceous earth, and flux-calcined diatomaceous earth. For water-based versions of such paint compositions, any water-dispersible binder, such as polyvinyl alcohol (PVA) and acrylics may be used. Paint compositions disclosed herein may also comprise other conventional additives, including, but not limited to, surfactants, thickeners, defoamers, wetting agents, dispersants, solvents, and coalescents.

Paper coatings disclosed herein can include, in addition to the calcined kaolin as described above, materials generally used in the production of paper coatings and paper fillers. The compositions can include a binder and a pigment, such as TiO₂. The coatings may optionally include other additives, including, but not limited to, dispersants, cross linkers, water retention aids, viscosity modifiers or thickeners, lubricity or calendering aids, antifoamers/defoamers, gloss-ink hold-out additives, dry or wet rub improvement or abrasion resistance additives, dry or wet pick improvement additives, optical brightening agents or fluorescent whitening agents, dyes, biocides, leveling or evening aids, grease or oil resistance additives, water resistance additives and/or insolubilizers.

Any art recognized binder may be used in the compositions and products disclosed herein. Exemplary binders include, but are not limited to, adhesives derived from natural starch obtained from a known plant source, for example, wheat, corn, potato or tapioca; and synthetic binders, including styrene butadiene, acrylic latex, vinyl acetate latex, or styrene acrylic, casein, polyvinyl alcohol, polyvinyl acetate, or mixtures thereof.

Paper coatings have very different binder levels depending upon the type of printing to be used with the coated paper product. Appropriate binder levels based upon the desired end product would be readily apparent to the skilled artisan. Binder levels are controlled to allow the surfaces to receive ink without disruption. The latex binder levels for paper coatings generally range from about 3% to about 30%. In one aspect, the binder is present in the paper coating in an amount of from about 3% to about 10%. In another aspect, the binder is present in the coating in an amount ranging from about 10% to about 30% by weight.

The present disclosure also provides a polymer comprising the calcined composition as described herein.

In addition, the present disclosure provides a feed for a ceramic, wherein the feed comprises the calcined feed as described herein. The ceramic can be used for supporting a catalyst, e.g., such as a catalyst used in a catalytic converter. In another aspect, the ceramic comprises the catalyst.

Even further disclosed herein are products comprising the disclosed compositions such as: coatings, e.g. non-aqueous coatings for paper; inks; paints; polymer products; rubber products; and barrier coating compositions.

In one aspect, the present disclosure provides a coating, such as a non-aqueous coating for paper or paperboard, comprising the calcined products, such as calcined kaolin, disclosed herein. The coating can further comprise at least one binder chosen from binders conventionally used in the art. Exemplary binders include, but are not limited to, adhesives derived from natural starch and synthetic binders, including, for example, styrene butadiene, acrylic latex, vinyl acetate latex, or styrene acrylic, casein, polyvinyl alcohol, polyvinyl acetate, or mixtures thereof.

Paper and paper board coatings may have different binder levels depending on the end use of the coated product. Appropriate binder levels based upon the desired end product would be readily apparent to the skilled artisan. For example, binder levels can be controlled to allow the surfaces to receive ink without disruption. The latex binder levels for paper or paper board coatings generally range from 3% to 30% by weight relative to the total weight of the coating. For example, the at least one binder can be present in an amount ranging from 3% to 30%, such as from 10% to 30%, by weight relative to the total weight of the coating. Paper or paper board coatings can include the kaolins disclosed herein in an amount ranging from about 3% to about 95% by weight on a dry coating basis.

Another aspect provides a coated paper comprising a fibrous substrate and a coating on the substrate comprising a paper coating composition as described above.

In one embodiment, the present disclosure provides an ink comprising, in an appropriate medium, the kaolins disclosed herein. The “ink” disclosed herein can be chosen from aqueous inks and non-aqueous inks, including, for example, gravure inks, heat-set inks, lithographic printing inks, and newsprint inks. The products disclosed herein can serve, for example, as a pigment in the ink and can provide economic advantage to the ink product, as they can exhibit high dispersion rate in both aqueous medium and non-aqueous medium.

The appropriate medium in the ink disclosed herein can be chosen from aqueous media and non-aqueous media conventionally used in the art.

Depending on the final applications of the ink, the ink disclosed herein can further comprise at least one component chosen, for example, from resins, such as vinyl resins; polymers; additives, such as rheology modifiers, surfactants, and drying accelerating agents such as sodium lauryl sulfate, N,N-diethyl-m-toluamide, cyclohexylpyrrolidinone and butyl carbitol; fillers; diluents; humectants, such as ethylene glycol, propylene glycol, diethylene glycols, glycerine, dipropylene glycols, polyethylene glycols, polypropylene glycols, amides, ethers, carboxylic acids, esters, alcohols, organosulfides, organosulfoxides, sulfones, alcohol derivatives, carbitol, butyl carbitol, cellosolve, ether derivatives, amino alcohols, and ketones; and biocides, such as benzoates, sorbates, and isothiazolones. The ink product can further comprise at least one additional pigment chosen from those conventionally used in the art.

The amount of calcined product disclosed herein in a given ink can vary greatly based on the formulation of the ink, as would be apparent to one of ordinary skill in the art. For example, in some aspects the kaolin can comprise from 5%-45% by weight of the ink as formulated.

In another aspect, the present disclosure provides a paint, such as an aqueous or non-aqueous industrial coating, architectural paint, deco paint, or art paint, comprising, in an appropriate medium, the calcined products disclosed herein. The calcined products disclosed herein can serve, for example, as a gloss control agent pigment in the paint. The calcined products can generally be present in an amount less than the critical pigment volume. However, the pigments can also be present in higher pigment volume concentrations, such as for example in the range of 1% to 80% by weight on a dry film basis.

The paint disclosed herein can further comprise at least one component chosen from binders, such as polymeric binders, for example, water dispersible binders chosen, for example, from polyvinyl alcohol (PVA) and latex; and additives conventionally used in paints, chosen, for example, from surfactants, thickeners, biocides, defoamers, wetting agents, dispersants, and coalescents. The paint disclosed herein can comprise at least one additional pigment chosen, for example, from TiO₂ and calcium carbonate.

In another aspect, the present disclosure provides a polymer product comprising the calcined products disclosed herein. The calcined products can be present at a concentration of up to 60% by weight of the polymer as compounded and up to 30% by weight of the final polymer article. The calcined products can be used for at least one application chosen from resin extension (i.e., filling), TiO₂ extension, and reinforcement of the polymer.

The polymer product disclosed herein may comprise at least one polymer resin. The term “resin” means a polymeric material, either solid or liquid, prior to shaping into a plastic article. The at least one polymer resin can be one which, on cooling (in the case of thermoplastic plastics) or curing (in the case of thermosetting plastics), can form a plastic material.

The at least one polymer resin, which can be used herein, can be chosen, for example, from polyolefin resins, polyamide resins, polyester resins, engineering polymers, allyl resins, thermoplastic resins, and thermoset resins.

In another aspect, the present disclosure provides a rubber product comprising the calcined products disclosed herein. The products can provide the benefits of resin extension, reinforcement of the rubber, and increased hardness of the rubber composition. The rubber product disclosed herein comprises at least one rubber chosen from natural rubbers and synthetic rubbers. For example, sulphur-vulcanisable rubbers, which can be used for manufacture of tire treads can be used in the products and methods disclosed herein. Examples of synthetic rubbers include, but are not limited to, styrene-butadiene rubber (SBR), vinyl-styrene-butadiene rubber (VSBR), butadiene rubber (BR), and neoprene rubber or polyisoprene. The SBR may be emulsion SBR (E-SBR) or solution SBR (S-SBR). The VSBR may be solution VSBR (S-VSBR). And examples of the BR include, but are not limited to, cis-1,3-polybutadiene rubber and cis-1,4-polybutadiene rubber. An example of the natural rubbers, which can be used, is Standard Malaysian natural rubber.

The rubber product disclosed herein may further comprise at least one additive chosen from conventional additives used in the art, for example, extender oils and mineral and synthetic fillers. The rubber can include the kaolin in an amount up to 35% by weight as formulated.

Another aspect of the present disclosure provides a method of making a barrier coating from a fine kaolin having the properties described herein. Barrier coatings are useful to impart to paper resistance to moisture, moisture vapor, grease, oil, air, etc. When making barrier coatings, the amount of binder in the formulation may be very high on the order of 40% to 50%.

The present disclosure also provides a barrier coating composition, comprising a slurry comprising the calcined kaolin described herein. The solids content of the slurry can range from about 45% to about 70%.

Another aspect of the present disclosure provides a method of improving barrier properties in a paper comprising coating a fibrous substrate with a paper coating composition comprising calcined products as described herein.

The invention will be further clarified by the following non-limiting examples, which are intended to be purely exemplary of the invention.

### EXAMPLE 1

This Example provides comparative data for mixtures comprising kaolin and various combinations of fuel oil and TiO₂ additive. The hydrous kaolin used was obtained commercially as Alphatex (commercially available from Imerys). The fuel oil used was a standard No. 2 diesel fuel oil. Control sample 1 is a sample of Alphatex that was calcined without adding either fuel oil or TiO₂. Samples 2-5 illustrate the effect of pre-calcination coating of the sample with varying amounts of fuel oil. Samples 6-9 illustrate the effect of pre-calcination addition of varying amounts of TiO₂. Samples 10-13 illustrate the effects of pre-calcination coating with a mixture of fuel oil and a TiO₂ additive in accordance with one aspect of the present invention.

The coating process for all coated samples was performed for 10 minutes in a Ross® Planetary mixer at a 4.5 speed setting. The samples were then calcined in a kiln at 1080° C. for 30 minutes. Tables I-III show the results of calcining Samples 1-5 (Table I), Samples 6-9 (Table II), and the inventive Samples 10-13 (Table III), as indicated by the following data: GE Brightness, Hunter L* a* b* coordinates, where the more negative “a” value and the lower “b” value are indicative of better product quality, % residue (+325 mesh material), Einlehner Abrasion values, and particle size data.

TABLE I
After calcining Samples 1-5

| | Sample | | | | |
|---|---|---|---|---|---|
| | #1 | #2 | #3 | #4 | #5 |
| Fuel Oil | — | 5#/ton | 10#/ton | 15#/ton | 20#/ton |
| Addition | | | | | |
| TiO₂ Addition | — | — | — | — | — |
| Brightness | 92.77 | 93.13 | 93.21 | 93.31 | 93.32 |
| L | 97.78 | 97.87 | 97.92 | 97.93 | 97.95 |
| a | −0.17 | −0.22 | −0.27 | −0.27 | −0.25 |
| b | 2.42 | 2.3 | 2.3 | 2.22 | 2.23 |
| PSD | | | | | |
| 10 μm | 99.3 | 98.8 | 99.2 | 98.9 | 98.8 |
| 5 μm | 96.6 | 96.1 | 97.4 | 96.7 | 96.8 |
| 2 μm | 89.1 | 88.6 | 90.6 | 90 | 89.6 |
| 1 μm | 78.0 | 75.6 | 77.5 | 78.6 | 76.1 |
| 0.5 μm | 34.3 | 26.8 | 25.2 | 30.3 | 24 |
| 0.25 μm | 4.3 | 3.7 | 2.9 | 4.9 | 4.4 |
| % Residue | 0.04 | 0.08 | 0.1349 | 0.2189 | 0.4148 |
| Abrasion | 4.3 | 5.6 | 5.8 | 5.4 | 6.1 |

TABLE II
After calcining Samples 6-9

| | Sample | | | |
|---|---|---|---|---|
| | #6 | #7 | #8 | #9 |
| Fuel Oil Addition | — | — | — | — |
| TiO₂ Addition | 7.5#/ton | 15#/ton | 20#/ton | 30#/ton |
| Brightness | 92.67 | 92.47 | 92.21 | 91.61 |
| L | 92.67 | 97.7 | 97.64 | 97.47 |
| a | −0.14 | −0.16 | −0.16 | −0.12 |
| b | 2.43 | 2.52 | 2.63 | 2.85 |
| PSD | | | | |
| 10 μm | 98.2 | 99.1 | 98.4 | 97.5 |
| 5 μm | 96.4 | 97 | 96.3 | 95.6 |
| 2 μm | 89.7 | 90.6 | 89.9 | 88.4 |
| 1 μm | 78.4 | 79.4 | 79.3 | 77.3 |
| 0.5 μm | 28.6 | 28.8 | 31.5 | 30.6 |
| 0.25 μm | 4.6 | 3.1 | 5.2 | 5.4 |
| % Residue | 0.4176 | 0.4376 | 0.4831 | 0.6494 |
| Abrasion | 5 | 5.2 | 5.1 | 5.6 |

TABLE III
After calcining inventive Samples 10-13

| | Sample | | | |
|---|---|---|---|---|
| | #10 | #11 | #12 | #13 |
| Fuel Oil Addition | 5#/ton | 10#/ton | 15#/ton | 20#/ton |
| TiO₂ Addition | 7.5#/ton | 15#/ton | 20#/ton | 30#/ton |
| Brightness | 92.63 | 93.16 | 93.2 | 93.08 |
| L | 97.74 | 97.89 | 97.9 | 97.83 |
| a | −0.10 | −0.19 | −0.19 | −0.28 |
| b | 2.44 | 2.27 | 2.29 | 2.38 |
| PSD | | | | |
| 10 μm | 98.6 | 98.3 | 98.9 | 97.6 |
| 5 μm | 96 | 95.3 | 96.2 | 93.8 |
| 2 μm | 88.4 | 87.9 | 88.5 | 84.6 |
| 1 μm | 75.9 | 75.6 | 75.8 | 70.6 |
| .5 μm | 25.9 | 25.5 | 24 | 22 |
| .25 μm | 3.8 | 2.8 | 4.2 | 2.1 |
| % Residue | 0.3474 | 0.4111 | 0.5474 | 0.5151 |
| Abrasion | 4.9 | 4.9 | 4.93 | na |

As illustrated above, increased brightness and superior color (i.e., more negative ‘a’ and lower ‘b’ values) can be obtained when calcining a kaolin that has been coated with increasing amounts of fuel oil (samples 2-5). TiO₂ is typically added to increase opacity and light scatter in some end-use applications, but can have deleterious effects on brightness and color as illustrated by samples 6-9. Inventive samples 10-13 illustrate that the adverse brightness and color effects of TiO₂ addition can be largely mitigated by adding the TiO₂ via the inventive method of pre-coating the kaolin with a fuel oil/TiO₂ mixture prior to calcination. Thus, it is surprisingly possible to obtain the beneficial opacity and light scatter effects of TiO₂ while minimizing the adverse effects on brightness and color.

Other aspects of the invention will be apparent to those skilled in the art from consideration of the specification and practice of the invention disclosed herein. It is intended that the specification and examples be considered as exemplary only, with a true scope and spirit of the invention being indicated by the following claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

1. A method of heat-treating, comprising:
(a) combining at least one additive in a liquid fuel to form an additive/liquid fuel mixture;
(b) coating at least a portion of a particulate material with the additive/liquid fuel mixture to form a coated particulate material; and
(c) heating the coated particulate material to calcine the particulate material and burn the liquid fuel to form a heat-treated product.

2. The method according to claim 1, wherein the particulate material comprises a material chosen from minerals, rocks, cement raw materials, and ceramics raw materials.

3. The method according to claim 1, wherein the particulate material comprises kaolin.

4. The method according to claim 3, wherein the kaolin is chosen from hydrous kaolin and calcined kaolin.

5. The method according to claim 1, wherein the particulate material comprises particulate hydrous kaolin having a mean dispersed particle size less than about 2 μm.

6. The method according to claim 2, wherein the particulate material comprises a mineral chosen from alumina, limestone, bauxite, gypsum, magnesium carbonate, calcium carbonate, dolomite, diatomite, and spodumene.

7. The method according to claim 1, wherein the heat-treated product from (c) comprises a calcined product.

8. The method according to claim 7, wherein the calcined product is chosen from calcined kaolin, calcined alumina, calcined lime, calcined gypsum, calcined/fused magnesium carbonate, calcined calcium carbonate, calcined dolomite, calcined spodumene, calcined diatomite, cement and ceramics product.

9. The method according to claim 1, wherein the liquid fuel comprises a hydrocarbon oil.

10. The method according to claim 9, wherein the hydrocarbon oil is chosen from fuel oils, vegetable oils, modified vegetable oils, waste oils, aliphatic and aromatic alcohols, and biodiesels.

11. The method according to claim 10, wherein the fuel oils are chosen from petroleum, mineral oil, turpentine, kerosene, gasoline, diesel, No. 2 fuel oil, No. 4 fuel oil, No. 5 light fuel oil, No. 5 heavy fuel oil, and No. 6 fuel oil.

12. The method according to claim 10, wherein the vegetable oils are chosen from canola oil, soybean oil, corn oil, palm oil, olive oil, sunflower oil, cottonseed oil, peanut oil, sesame oil and safflower oil.

13. The method according to claim 10, wherein the modified vegetable oils are chosen from methyl-, ethyl-, propyl-, and butyl esters of canola oil, soybean oil, corn oil, palm oil, olive oil, sunflower oil, cottonseed oil, peanut oil, sesame oil and safflower oil.

14. The method according to claim 10, wherein the waste oils are chosen from waste fat, grease oil, motor oil, and biodiesel of waste oils.

15. The method according to claim 1, wherein at least about 50% of the particulate material is coated with the additive/liquid fuel mixture.

16. (canceled)

17. The method according to claim 1, wherein the liquid fuel is present in the coated particulate material in an amount ranging from about 0.01% to about 5% by weight, relative to the total weight of the coated particulate material.

18. (canceled)

19. The method according to claim 1, wherein the combining in (a) comprises dispersing the additive in the liquid fuel mixture to form an additive/liquid fuel dispersion.

20. The method according to claim 19, wherein the dispersing is performed in the presence of at least one dispersant to maintain a suspension.

21. The method according to claim 20, wherein the at least one dispersant is chosen from acrylate based organic dispersants, etheylene oxide-propylene oxide co-polymers, inorganic dispersants, alcohol-based dispersants, soya lecithin-based dispersants, and sorbitan-based dispersants.

22. (canceled)

23. (canceled)

24. (canceled)

25. (canceled)

26. The method according to claim 19, wherein the dispersing comprises mixing the additive in the liquid fuel mixture with a high intensity mixer.

27. The method according to claim 1, wherein the at least one additive comprises at least one mineral.

28. The method according to claim 27, wherein the at least one mineral is chosen from zirconia, silica, diatomite, aluminum trihydrate, calcium oxide, magnesium oxide, and calcium carbonate.

29. The method according to claim 27, wherein the at least one mineral is chosen from TiO₂.

30. The method according to claim 1, wherein the at least one additive comprises at least one metal.

31. (canceled)

32. (canceled)

33. (canceled)

34. (canceled)

35. The method according to claim 1, wherein the coating in (b) comprises coating in a mixer.

36. The method according to claim 35, wherein the coating comprises subjecting the particulate material and the additive/liquid fuel mixture to a rotational speed of from about 2,000 to about 4,000 rpm.

37. (canceled)

38. The method according to claim 35, wherein the coating comprises subjecting the particulate material and the additive/liquid fuel mixture in the mixer to a tip speed of less than about 10,000 feet per minute.

39. (canceled)

40. The method according to claim 39, wherein the mixer is a screw feed auger.

41. The method according to claim 1, wherein the heating in (c) comprises heating the feed mixture to at least one temperature of at least about 100° C.

42. The method according to claim 1, wherein the heating in (c) comprises heating the feed mixture to at least one temperature of at least about 1000° C.

43. (canceled)

44. (canceled)

45. (canceled)

46. (canceled)

47. The method according to claim 1, wherein the particulate material comprises particulate hydrous kaolin, and the heating in (c) comprises heating the feed mixture to at least one temperature ranging from about 500° C. to about 1250° C. for a time sufficient to at least partially dehydroxylate the hydrous kaolin.

48. (canceled)

49. (canceled)

50. (canceled)

51. The method according to claim 1, wherein the particulate material comprises particulate hydrous kaolin, and the product of the heating in (c) comprises a product chosen from one of partially calcined kaolin, fully calcined kaolin, flash calcined kaolin, and mullite.

52. (canceled)

53. (canceled)

54. (canceled)

55. The method according to claim 1, wherein the heating in (c) is performed by using at least one of a rotary kiln, a vertical kiln, a flash calciner and a tunnel kiln.

56. The method according to claim 1, wherein the particulate material in (b) is finely disseminated.

57. The method according to claim 1, wherein the particulate material in (b) has a mean dispersed particle size ranging from about 0.1 μm to about 500 μm.

58. (canceled)

59. (canceled)

60. The method according to claim 7, wherein the calcined product in (c) has a steepness value of at least about 58, as determined by the ratio d₃₀/d₇₀×100.

61. (canceled)

62. A paint, polymer, feed for a ceramic, or paper coating composition comprising the calcined product from (c) according to claim 7.

63. (canceled)

64. (canceled)

65. A ceramic for supporting a catalyst, the ceramic being obtained from the calcined product from (c) according to claim 7.

66. (canceled)

67. A feed mixture, comprising:
a particulate feed chosen from aggregates and discrete particles, wherein at least a portion of the particulate feed is coated with an additive/liquid fuel mixture, the mixture comprising at least one additive dispersed in liquid fuel.

68. The feed mixture according to claim 67, wherein the additive is chosen from zirconia, silica, alumina, aluminum trihydrate, limestone, dolomite, diatomite, spodumene, calcium oxide, magnesium oxide, gypsum, magnesium carbonate and calcium carbonate, other cement raw materials and ceramics raw materials.

69. The feed mixture according to claim 67, wherein the additive is chosen from TiO₂.

70. The feed mixture according to claim 67, wherein the particulate feed is chosen from kaolin, alumina, limestone, bauxite, gypsum, magnesium carbonate, calcium carbonate, dolomite, diatomite, spodumene, cement raw materials and ceramics raw materials.

71. The feed mixture according to claim 67, wherein the particulate feed comprises hydrous kaolin and the additive comprises TiO₂.

72. A system for heat-treating a particulate material, comprising:
(a) a mixer for receiving and mixing particulate material with an additive/liquid fuel mixture to form a coated particulate feed, the additive/liquid fuel mixture comprising at least one additive dispersed in liquid fuel; and
(b) a heat source for heating the coated particulate feed and for burning the liquid fuel.

73. The system according to claim 72, wherein the mixer is chosen from a high intensity mixer and a low intensity mixer.

74. (canceled)

75. The system according to claim 72, wherein the heat source is chosen from a rotary kiln, a vertical kiln, a flash kiln, and a tunnel kiln.

76. The system according to claim 72, further comprising a screw feeder for metering the coated particulate feed to the heat source.

77. The system according to claim 72, wherein the particulate material is chosen from minerals, rocks, cement raw materials, and ceramics raw materials.

78. The system according to claim 77, wherein the particulate material comprises a mineral chosen from kaolin, alumina, limestone, bauxite, gypsum, magnesium carbonate, calcium carbonate, dolomite, diatomite, and spodumene.

79. The system according to claim 72, wherein the product exiting the heat source is chosen from calcined products, sintered products, aggregated products, porous products, abrasive products, refractory products, and cementicious products.

80. The system according to claim 79, wherein the product exiting the heat source is a calcined product chosen from calcined kaolin, calcined alumina, calcined lime, calcined bauxite, calcined gypsum, calcined/fused magnesium carbonate, calcined calcium carbonate, calcined dolomite, calcined spodumene, calcined diatomite, cement, ceramics products, abrasive products, and refractory products.

81. The system according to claim 72, wherein the product exiting the heat source in (b) has a steeper particle size distribution than the particulate material in (a).

82. The system according to claim 81, wherein the product exiting the heat source has a steepness value of at least about 58, as determined by the ratio d₃₀/d₇₀×100.

83. (canceled)

84. The system according to claim 72, wherein the mixer coats at least a portion of the particulate material with the liquid fuel.

85. A method for calcining kaolin, comprising:
(a) combining at least one additive in a liquid fuel to form an additive/liquid fuel mixture;
(b) providing a particulate feed comprising particulate hydrous kaolin, wherein at least a portion of the particulate hydrous kaolin is coated with the additive/liquid fuel mixture; and
(c) heating the particulate feed to at least partially dehydroxylate the hydrous kaolin and burn the liquid fuel.

86. The method according to claim 85, wherein the additive comprises TiO₂.

87. (canceled)

88. (canceled)
